(19) United States
(12) Patent Application Publication
(10) Pub. No.: US 2018/0263218 A1
(43) Pub. Date: Sep. 20, 2018

(54) ANIMAL HARNESS

(71) Applicant: Doskocil Manufacturing Company, Inc., Arlington, TX (US)

(72) Inventor: Jack RENFORTH, Azle, TX (US)

(21) Appl. No.: 15/907,833

(22) Filed: Feb. 28, 2018

Related U.S. Application Data
(60) Provisional application No. 62/473,798, filed on Mar. 20, 2017.

(51) Int. Cl. A01K 27/00; A01K 13/00

(52) U.S. Cl. CPC A01K 27/002; A01K 27/003; A01K 13/006; A01K 27/005

(57) ABSTRACT

An animal harness includes a vest portion and a buckling member. The vest portion includes a first strap and a second strap. The bucking member includes a first bucking portion slidably attached to the first strap and a second bucking portion slidably attached to the second strap. The first bucking portion configured to detachably couple to the second bucking portion, and the first and second bucking portions being configured to slide along the first and second strap when coupled together.

### CROSS REFERENCE TO RELATED APPLICATIONS

This application claims priority to U.S. Provisional Application No. 62/473,798, filed Mar. 20, 2017, the contents of which are hereby incorporated herein by reference.

### FIELD OF THE INVENTION

The present invention relates to an animal harness. In particular, the present invention relates to an animal harness with an improved buckle design.

### DESCRIPTION OF RELATED ART

Conventional animal harnesses are known for walking, training and carrying. Conventional harnesses have one portion that encircles the neck or upper body of the animal and another portion that encircles the torso. These two portions are generally coupled together along the back of the animal. Harnesses can be safer for the animal, since force is distributed evenly over the animal's body. Therefore, jerking of the animal's head is unlikely during walking or training, consequently there is little or no chance of injury to the neck area.

### SUMMARY

It has been discovered that a more effective animal harness can include an improved buckling structure a animal harness according to one embodiment includes a vest portion and a buckling member. The vest portion includes a first strap and a second strap. The bucking member includes a first bucking portion slidably attached to the first strap and a second bucking portion slidably attached to the second strap. The first bucking portion configured to detachably couple to the second bucking portion, and the first and second bucking portions being configured to slide along the first and second strap when coupled together.

### BRIEF DESCRIPTION OF THE DRAWINGS

Referring now to the attached drawings which form a part of this original disclosure:

FIG. 1 illustrates a bottom view of an animal harness in an uncoupled state according to an embodiment of the present invention;

FIG. 2 illustrates a top view of the animal harness of FIG. 1 in an uncoupled state;

FIG. 3 is an enlarged view of one end of the bottom view of the animal harness of FIG. 2;

FIG. 4 is enlarged bottom view of the end of the animal harness shown in FIG. 3;

FIG. 5 is a top view of the animal harness of FIG. 2 is a partially coupled state; and

FIG. 6 is a perspective views of the animal harness of FIG. 2 in a closed state.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

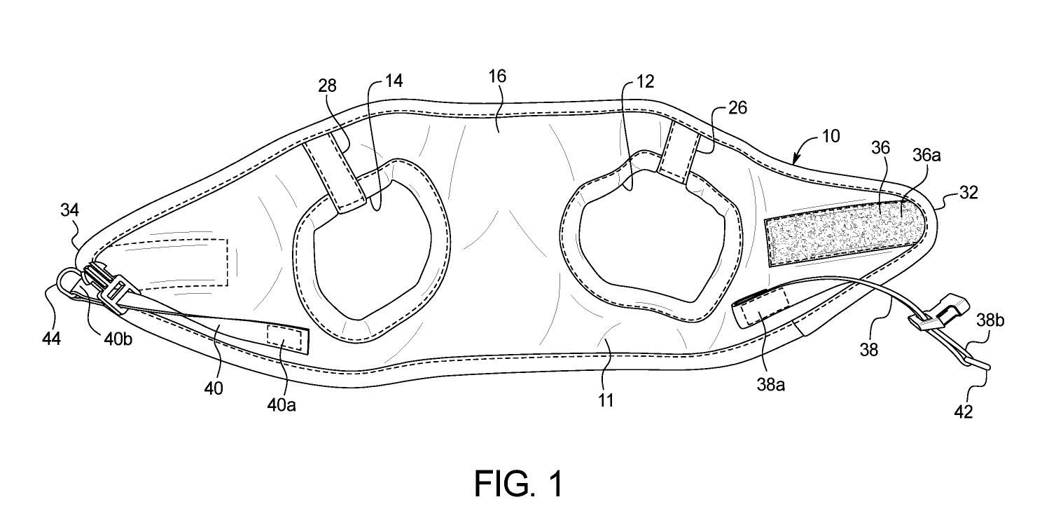

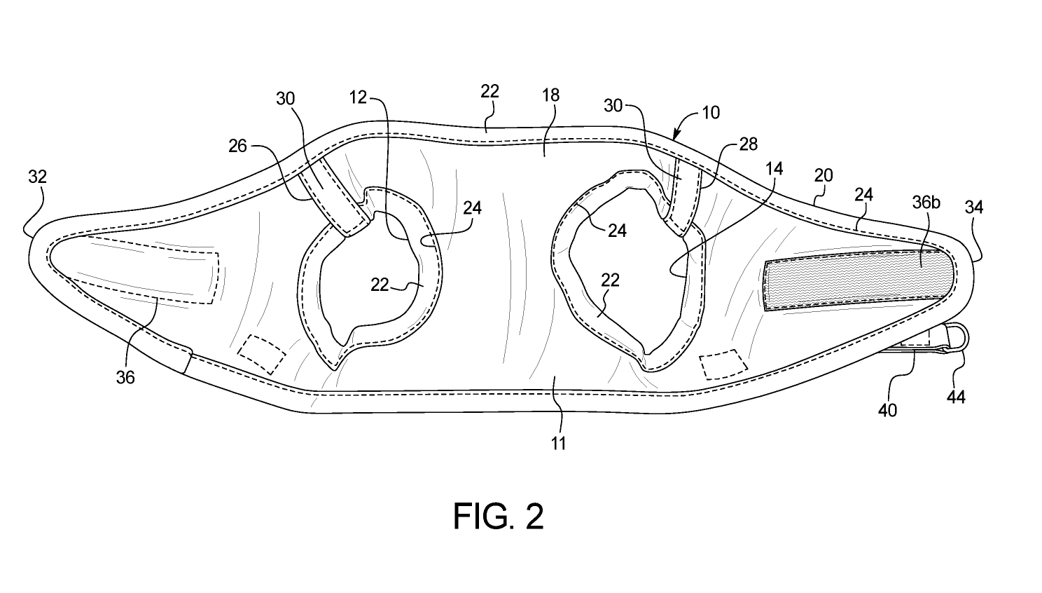

Referring initially to FIGS. 1-6, in the illustrated embodiment, the animal harness 10 is configured as a one-piece member. The harness 10 can be generally diamond shaped vest portion 11 with generally circular leg openings 12 and 14 for the animal's two front legs. The animal harness 10 can include an outer layer 16 and an inner layer 18 coupled or sewn together at the outer or peripheral edges 20 and the leg openings 12 and 14 with a stretchable perimeter material 22.

As can be understood, the stretchable perimeter material 22 can be folded over the outer or peripheral edges 20 and the leg openings 12 and 14, such the that the stretchable perimeter material 22 overlies a portion of the outer layer 16 and the inner 18 adjacent the peripheral edges 20 and the leg openings 12 and 14. The stretchable perimeter material 22 is then attached to the animal harness 10 using a thread 24 as is illustrated, or in any suitable manner.

First and second reinforcing strips or material 26 and 28 can extend from the leg openings 12 and 14 to the perimeter material 22. The first and second reinforcing strips 26 and 28 can extend from the perimeter material 22 disposed on the inner layer 18, along the inner 18 into a respective opening 12 and 14, and then back around along the outer layer 16 to the perimeter material 22 disposed on the outer layer 20. Similarly to the perimeter material 22, the first and second reinforcing strips 26 and 28 can be attached to the animal harness 10 using threads 30.

The outer and inner layers 16 and 18 can be made from a soft, stretchable mesh material. This material is suitable since it can “breath” and is comfortable against the animal's body. It is noted that the inner layer 18 and the outer layer 16 can be formed from any suitable material. Moreover, the inner layer 18 and the outer layer 16 can be one piece with the outer layer 16 being the outer surface of the material and the inner layer 18 being the inner surface of the material.

The animal harness 10 includes first and second ends 32 and 34 which include a hook and loop connector 36 (e.g., VELCRO) or any another suitable connector. In this embodiment, the outer layer 16 includes one of the hooks and loops (e.g., hooks 36a) at the first end 32 and the inner layer 18 includes the other of the hooks and loops (e.g., loops 36b) at the second end 34. As shown in FIG. 1, the hooks 34a are preferably a rectangular strip of material sewn into the outer layer 16, and the loops 36b are preferably a rectangular strip of material sewn into the inner layer 18. However, the hook and loop device 36 can be any suitable device connected to the animal harness 10 in any suitable manner. As can be understood, when connecting the ends of the harness together, the ends of the harness can overlap and attach together via the hook and loop connector 36 by the hooks 36a overlying and attaching to the loops 36b.

The outer surface 16 has first and second straps 38 and 40 attached thereto. In one embodiment, the first strap 38 is attached adjacent or near the hook portion 36a of the connector 36 adjacent the first end 32. The second strap 40 is attached near or adjacent the loop portion 36b of the connector 36 adjacent the second end 34. Each of the first and second straps 38 and 40 is connected to the harness at a proximal end 38a and 40a and has a metal ring 42 and 44 or other suitable structure for connecting to a leash at a distal end 38b and 40b.

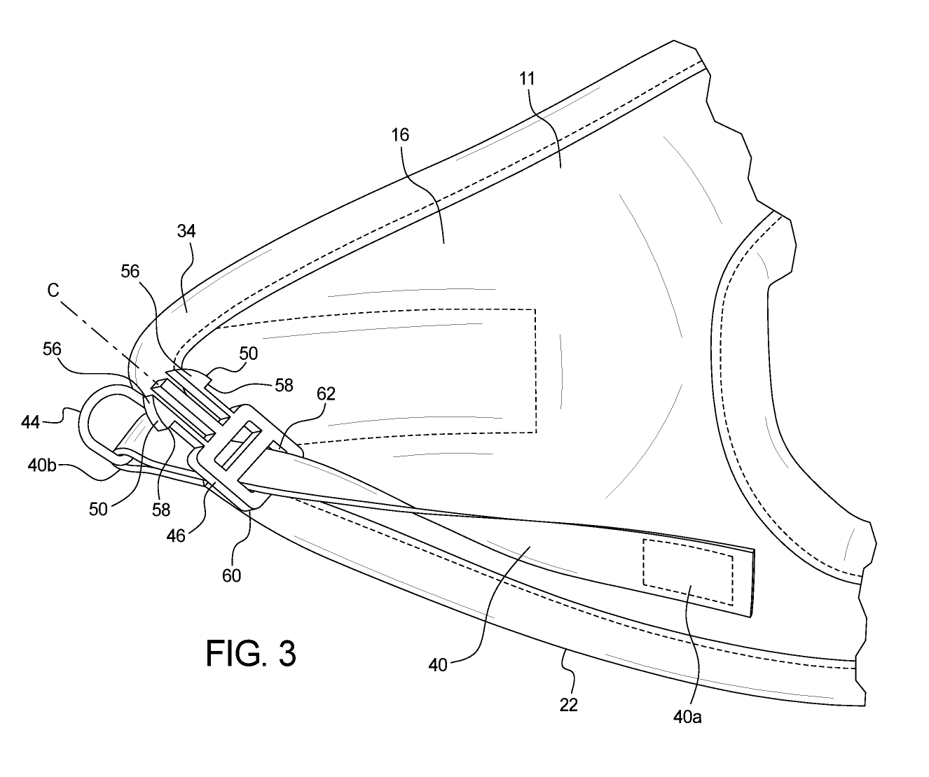

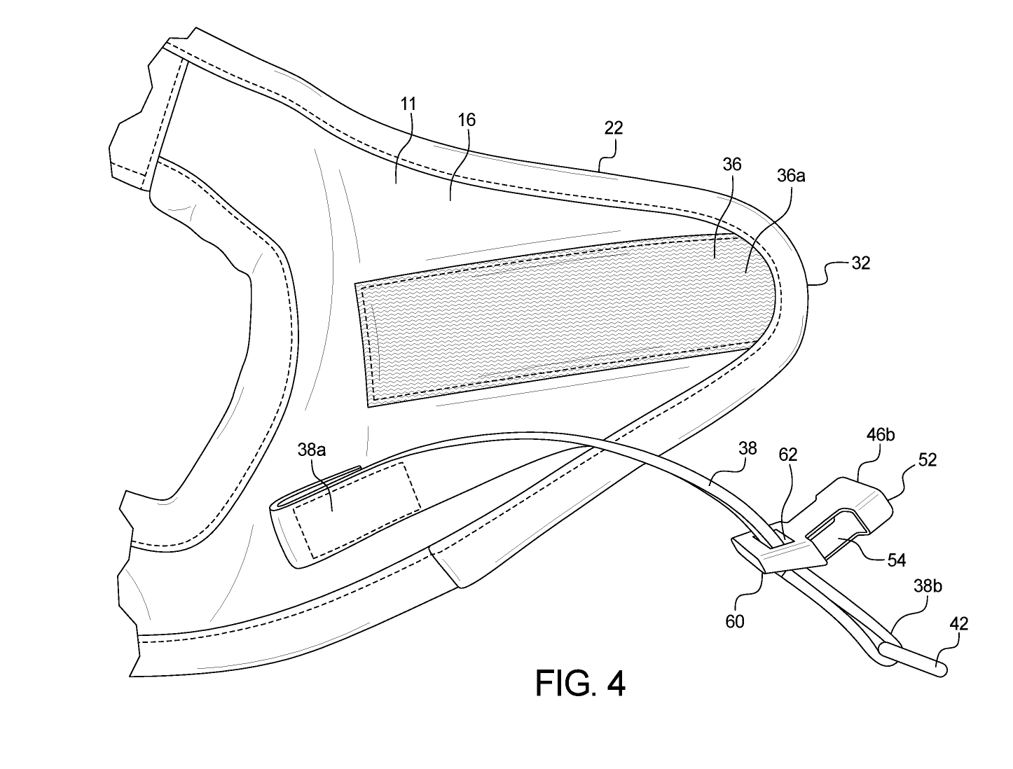

As is shown in FIGS. 3 and 4, each of the first and second straps 38 and 40 is an elongated strap that extends from a lower side of the animal harness 10. This portion of the harness 10, when the harness 10 is on an animal, is disposed away from the neck area on the back of the animal. At the proximal end 38a and 40b of each of the straps 38 and 40, the strap can be folded and sewn into the outer layer 16. This structure increases durability and strength of the strap at this portion. At the distal end 38b and 40b of each of the straps 38 and 40, the strap can be inserted into the respective metal ring 42 and 44 and sewn back on itself to retain the ring at the distal end thereof.

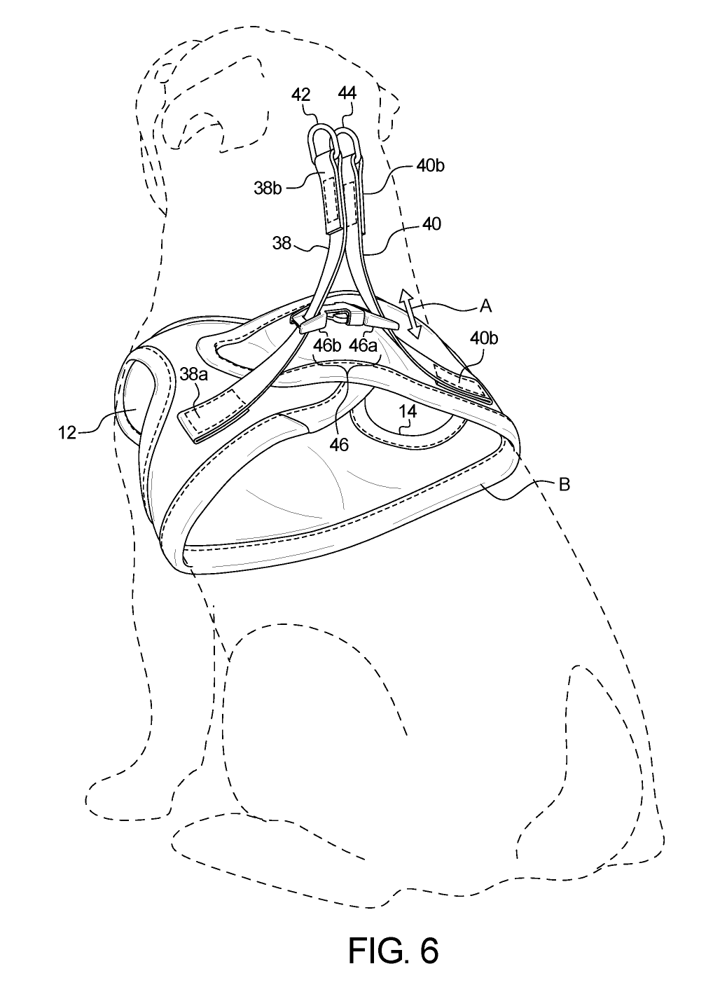

The buckling member 46 includes a first bucking portion 46a and a second bucking portion 46b. The first and second buckling portions 46a and 46b are configured to couple together. In one embodiment, the buckling member is a snap-fit buckle. As can be understood the snap-fit buckle generally includes one buckle portion (e.g., the first buckle portion 46a) that has two protrusions 50 that are capable of flexing inwardly toward the buckle centerline c, and another buckle portion (the second buckle portion 46b) that has a front opening 52 and two side openings 54 that enable access into the interior of the second buckle portion 46b. The protrusions 50 on the first buckle portion 46a have triangle heads 56 that can be flexed inwardly so as to enter the front opening 52 on the second buckle portion 46b and snap-fit outwardly into the side openings 54 as the buckle traverses the interior of the second buckle portion. As shown in FIG. 6, the edges 58 of the triangle heads 56 engage the walls to the openings 54 to maintain and latch the first buckle portion 46a with the second buckle portion 46b. To detach the first buckle portion 46a from the second buckle portion 46b, the protrusions 50 are biased inwardly along the buckle center line C, which disengages the edges 58 from the walls of the openings 54, allowing the first buckle portion 46a to be disengaged and pulled apart from the second buckle portion 46b.

The first and the second buckle portions 46a and 46b are connected the second and the first straps 40 and 38, respectively. As illustrated in FIGS. 3 and 4, each buckle portion 46a and 46b includes a base 60 that includes a substantially rectangular opening 62. The respective strap 38 and 40 passes through the respective opening 62 in the first and the second buckle portions 46a and 46b. The first and the second buckle portions 46a and 46b are therefore trapped between the proximal end of the respective strap and the metal hook at the distal end of the respective strap.

This embodiment enables each buckle portion 46a and 46b to be attached to a respective strap 40 and 38 such that the buckle portions 46a and 46b can float or slide along the strap 40 and 38 since the respective strap is capable of freely sliding through the opening 62. The buckle portions 46a and 46b are free to slide along the straps 40 and 38 both when uncoupled from each other and when coupled to each other.

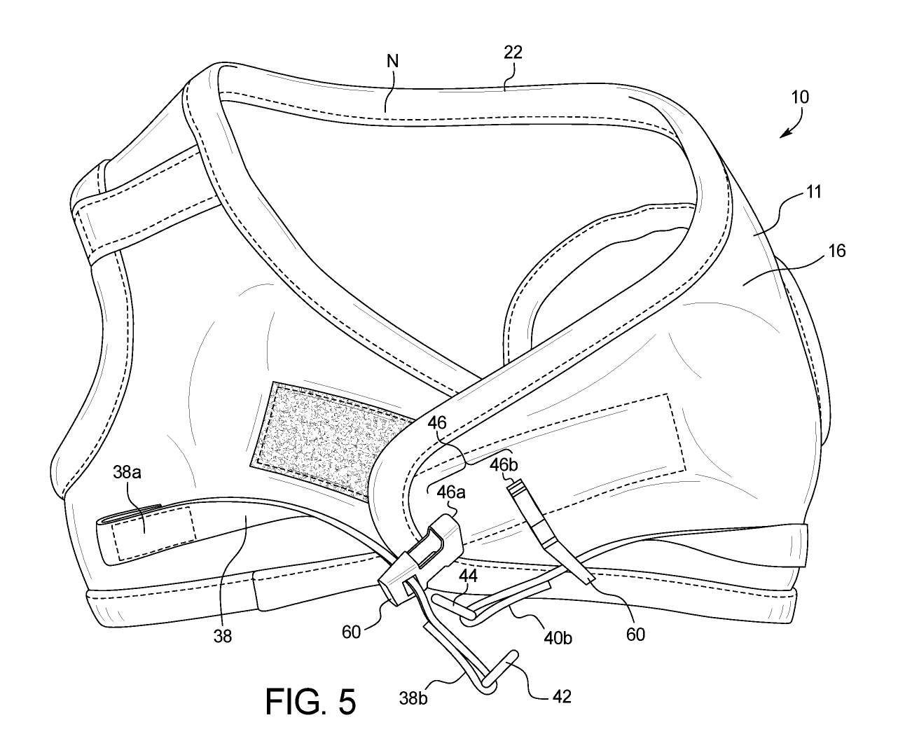

As can be understood, when using the harness 10, the animal's front legs are inserted through the first and second leg openings 12 and 14, the first and second ends 32 and 34 of the harness 10 are then coupled together on the animals back using the hook and loop connecter 36. As shown in FIGS. 5 and 6, the vest 11 forms a neck opening N for the animal's neck and a body opening B for the animal's body.

As discussed above, the harness 10 can be situated on the animal such that the first and second straps 38 and 40 are disposed in a position away from the head and neck of the animal. The first and second buckle portions 46a and 46b are then connected together as discussed above. When the user desires to use a leash, the leash connection portion is couple to both of the rings 42 and 44 at the distal ends 38b and 40b of the first and second straps 38 and 40.

During use of the leash, the buckling member 46 is allowed to float or slide along the straps as desired, as shown by arrow A. The sliding or floating of the buckling member 46 enables the buckling member 46 to self-adjust, thereby avoiding or eliminating any bunching or restricting of the harness at the overlapping end portions.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “portion” or “element” when used in the singular can have the dual meaning of a single part or a plurality of parts. Accordingly, these terms, as utilized to describe the present invention should be interpreted relative to a pet training device.

The terms of degree such as “generally” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An animal harness comprising:
a vest portion including a first strap and a second strap; and
a buckling member including a first bucking portion slidably attached to the first strap and a second bucking portion slidably attached to the second strap, the first bucking portion configured to detachably couple to the second bucking portion, and the first and second bucking portions being configured to slide along the first and second straps when coupled together.

2. The animal harness of claim 1, wherein
the vest portion includes a connector to enable the vest to be attached to an animal.

3. The animal harness of claim 2, wherein
the connector includes a first portion at a first end of the vest portion and a second portion at a second end of the vest portion.

4. The animal harness of claim 2, wherein
the connector is a hook and loop connector.

5. The animal harness of claim 1, wherein
each of the first and second straps includes a metal ring at a distal end thereof.

6. The animal harness of claim 6, wherein
each of the metal rings is configured to couple to a leash.

7. The animal harness of claim 1, wherein
the first buckling portion is configured to slide between distal and proximal ends of the first strap and the second buckling portion is configured to slide between distal and proximal ends of the second strap.

8. The animal harness of claim 1, wherein
the first and second straps are coupled to an outer surface of the vest.

9. The animal harness of claim 1, wherein
the first buckling portion snap fits with the second buckling portion.

10. The animal harness of claim 1, wherein
the vest portion includes a stretchable perimeter material sewn to a peripheral edge.
